(19) United States
(12) Patent Application Publication
(10) Pub. No.: US 2020/0074507 A1
(43) Pub. Date: Mar. 5, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Handa-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/556,350

(22) Filed: Aug. 30, 2019

(30) Foreign Application Priority Data
Sep. 5, 2018 (JP) 2018-165940

(51) Int. Cl. G06Q 30/02; G06F 16/9537

(52) U.S. Cl. CPC G06Q 30/0266; G06F 16/9537

(57) ABSTRACT

An information processing apparatus comprising a controller configured to execute the processing of: acquiring information relating to the environment around a vehicle that is capable of outputting an advertisement by a plurality of outwardly facing display apparatuses provided at different positions; selecting a display apparatus to which the advertisement is to be output from among the plurality of display apparatuses on the basis of the environment around the vehicle; and outputting the advertisement to the selected display apparatus.

### CROSS REFERENCE TO RELATED APPLICATION

This application claims the benefit of Japanese Patent Application No. 2018-165940, filed on Sep. 5, 2018, which is hereby incorporated by reference herein in its entirety.

### BACKGROUND

### Technical Field

The present invention relates to technologies of providing advertisements using vehicles as media.

### Description of the Related Art

Advertising using vehicles as media has been developed in recent years. For example, an outside display apparatus is provided on a vehicle to display advertisements. The advertisement to be displayed is dynamically selected appropriately according to circumstances to optimize the effect of advertising.

### CITATION LIST

### Patent Literature

Patent Literature 1: Japanese Patent Application Laid-Open No. 2004-361661

### SUMMARY

To enhance the effect of advertisements displayed using vehicles as media, it is desirable that appropriate types of advertisement that are suitable for the environment of the vehicles be displayed.

The present invention has been made in the above circumstances, and an object of the present invention is to enhance the effect of advertisements that are displayed using vehicles as media.

The present invention in its one aspect provides an information processing apparatus comprising a controller configured to execute the processing of: acquiring information relating to the environment around a vehicle that is capable of outputting an advertisement by a plurality of outwardly facing display apparatuses provided at different positions; selecting a display apparatus to which the advertisement is to be output from among the plurality of display apparatuses on the basis of the environment around the vehicle; and outputting the advertisement to the selected display apparatus.

The present invention in its another aspect provides an information processing method executed by an information processing apparatus, the method comprising the steps of: acquiring information relating to the environment around a vehicle that is capable of outputting an advertisement by a plurality of outwardly facing display apparatuses provided at different positions; selecting a display apparatus to which the advertisement is to be output from among the plurality of display apparatuses on the basis of the environment around the vehicle; and outputting the advertisement to the selected display apparatus.

According to a third aspect of the present invention, there is provided a program that causes a computer to implement the above-described information processing method or a computer-readable recording medium in which the program is stored in a non-transitory manner.

The present invention can enhance the effect of advertisements that are displayed using vehicles as media.

### BRIEF DESCRIPTION OF THE DRAWINGS

FIG. 1 is a diagram illustrating the general configuration of an advertisement distribution system according to an embodiment.

FIG. 2 is a diagram illustrating the system configuration of a vehicle 10 according to a first embodiment.

FIG. 3 illustrates the positions of display apparatuses provided on vehicles 10.

FIG. 4 is a diagram illustrating the system configuration of a server apparatus 20 according to the first embodiment.

FIG. 5 illustrates an example of an advertisement information table stored in a database.

FIG. 6 illustrates an example of a vehicle information table stored in a database.

FIG. 7 illustrates an example of a travel record table stored in a database.

FIG. 8 is a flow chart of a process executed by the server apparatus 20.

FIG. 9 is a flow chart of a first process executed by the vehicle 10.

FIG. 10 is a flow chart of a second process executed by the vehicle 10.

FIGS. 11A to 11C illustrate positions at which advertisements are displayed.

FIG. 12 shows an example of a determination table.

### DESCRIPTION OF THE EMBODIMENTS

An advertisement distribution system according to the present invention includes a server apparatus and a plurality of vehicles. The server apparatus distributes advertisements to the plurality of vehicles, and each vehicle displays an advertisement on its plurality of display apparatuses that face outward. Each vehicle in the system outputs an advertisement (in the form of a still or moving image) it has received from the server apparatus by the outside display apparatuses provided on the vehicle body while it is travelling.

When an advertisement is displayed using a plurality of display apparatuses provided on a vehicle, the effect of the advertisement varies among the display apparatuses provided at different positions on the vehicle. For example, the advertisement displayed on a display apparatus provided on a side of the vehicle mainly appeals to pedestrians, and the advertisement displayed on the display apparatus provided on the rear of the vehicle mainly appeals to a person(s) aboard a vehicle(s) that is running behind the aforementioned vehicle. To enhance the effectiveness of an advertisement, it is desirable to select a more appropriate display apparatus to display the advertisement.

An information processing apparatus according to the present invention acquires information relating to the environment around a vehicle capable of outputting an advertisement and selects a display apparatus to which the advertisement is to be output from among the plurality of display apparatuses on the basis of the environment around the vehicle. Moreover, the information processing apparatus outputs the advertisement to the apparatus thus selected.

The information relating to the environment around the vehicle includes information about the presence of consumers who potentially see advertisements. Examples of such information include information about the area in which the vehicle is travelling and information about the presence of other vehicles or pedestrians in the vicinity of the vehicle. The information relating to the environment around the vehicle may be obtained, for example, using sensor data acquired by the vehicle or using an external service.

Since a display apparatus to which the advertisement is to be output is selected based on the environment around the vehicle, it is possible to display the advertisement on the left side of the vehicle (in the case of left-hand traffic) in an area where there are many pedestrians and to display the advertisement on the rear of the vehicle when there are other vehicles running behind the subject vehicle (i.e. the vehicle that displays the advertisement).

The information relating to the environment around the vehicle may include information about the area in which the vehicle is travelling.

For example, an appropriate position on the vehicle at which an advertisement is to be displayed varies according to the properties of areas, such as that there are many pedestrians in a certain area and that there is much traffic in another area.

The information relating to the environment around the vehicle may include at least one of information about the state of distribution of pedestrians in the vicinity of the vehicle, information about the state of distribution of other vehicles in the vicinity of the vehicle, and information about the presence/absence of another vehicle that is running behind the vehicle.

Information about the state of distribution of pedestrians or other vehicles is information indicating how pedestrians or other vehicles are distributed about the subject vehicle. The number of pedestrians or other vehicles is not necessarily plural. The information about the state of distribution of pedestrians or other vehicles may be information indicating the position of a specific pedestrian or a specific vehicle relative to the subject vehicle.

When the information relating to the environment around the vehicle indicates that a pedestrian is present aside the vehicle, the controller may output the advertisement to a display apparatus provided on a side of the vehicle.

In this case, the advertisement may be displayed on a display apparatus provided on either the left side or the right side of the vehicle. When the vehicle is travelling on the road having two or more lanes, it is preferable that the advertisement be displayed on the left side (seen in the direction of travel) in the case of left-hand traffic.

When the information relating to the environment around the vehicle indicates that another vehicle is present behind the subject vehicle, the controller may output the advertisement to a display apparatus provided on the rear of the vehicle.

When the information relating to the environment around the vehicle indicates that another vehicle having a height larger than the subject vehicle is present behind it, the controller may output the advertisement to a display apparatus provided on the top of the vehicle.

When there is another vehicle(s) running behind the subject vehicle, it is preferred to select a display apparatus provided on the rear of the vehicle. However, when a vehicle larger (and taller) than the subject vehicle that displays the advertisement is running behind, a display apparatus provided on the top of the vehicle may be selected. This can provide advantages specific to large-size vehicles.

The controller may further obtain information relating to properties of the aforementioned another vehicle and determine the content of the advertisement based on the information about the aforementioned another vehicle.

Examples of the information relating to the properties of another vehicle include information about the size and/or model of that vehicle and the taste of the driver of that vehicle.

In the following, specific embodiments of the present invention will be described with reference to the drawings. It should be understood that features such as hardware configurations, module configurations, and functional configurations that will be described in connection with the embodiments are not intended to limit the technical scope of the present invention only to them, unless otherwise stated.

### First Embodiment

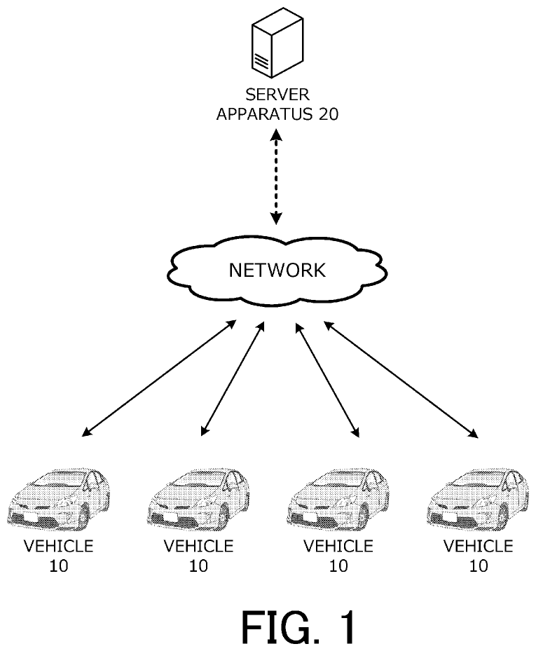

FIG. 1 illustrates the general configuration of an advertisement distribution system according to a first embodiment. The advertisement distribution system according to the first embodiment includes a plurality of vehicles 10 and a server apparatus 20.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10. In the following description of the embodiment, the term “users” will be used to refer to an intended audience of an advertisement output by the vehicles 10.

The vehicle 10 receives advertisement data from the server apparatus 20 and outputs an advertisement to the display apparatuses while it is travelling. The vehicle 10 periodically sends information about the state of display of an advertisement (e.g. location information and information identifying the advertisement displayed) to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

The vehicle 10 acquires information relating to the environment around it and selects a display apparatus to which an advertisement is to be output from among the plurality of display apparatuses on the basis of the acquired information. Thus, the advertisement can be displayed at a position that provides higher visibility of the advertisement for users. This can enhance the effectiveness of advertising.

The vehicles 10 and the server apparatus 20 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, and other wireless communication networks, such as Wi-Fi (registered trademark).

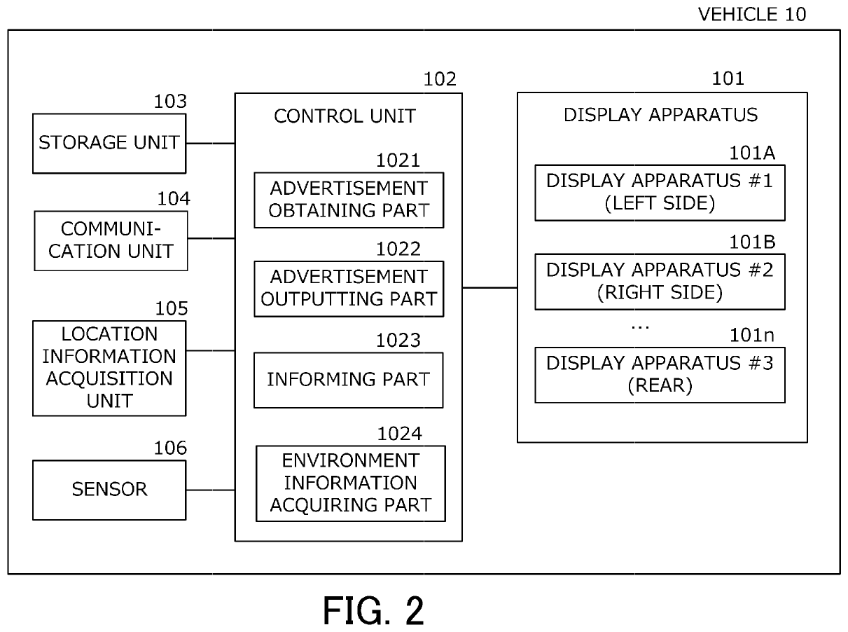

Now, the configuration of the vehicle 10 will be described. FIG. 2 is a diagram illustrating the system configuration of the vehicle 10.

The vehicle 10 includes a display unit 101, a control unit 102, a storage unit 103, a communication unit 104, a location information acquisition unit 105, and a sensor 106.

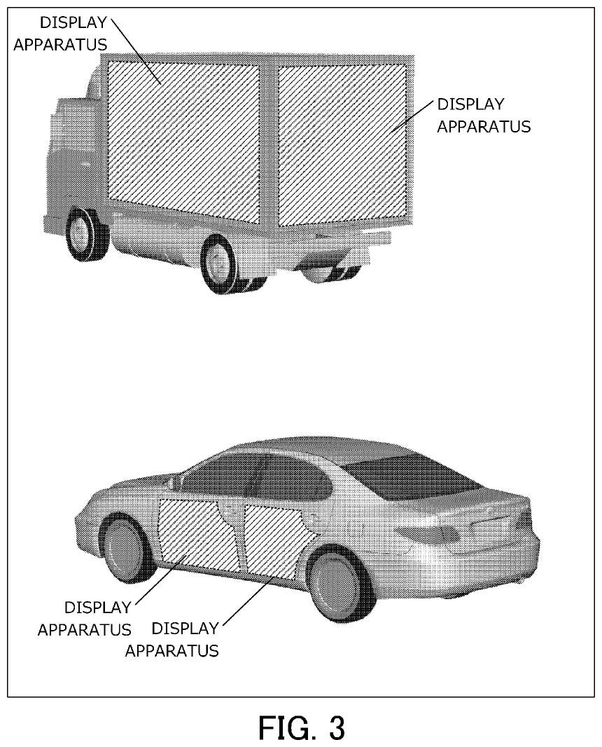

The display apparatus 101 includes a plurality of display apparatuses provided on the outside of the vehicle 10. As illustrated in FIG. 3, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side.

Display apparatuses 101 may be provided at positions other than those described above. For example, if it is possible to project images on a sheet of glass, display apparatuses may be provided on windows (e.g. side and rear windows). The display apparatus may be configured to project images on the road surface, a tire, or a tire wheel.

The control unit 102 is a computing device that controls the function of outputting advertisements among the functions of the vehicle 10. The control unit 102 may be implemented by a computational processing unit, such as a CPU (Central Processing Unit).

The control unit 102 includes four functional modules, which include an advertisement obtaining part 1021, an advertisement outputting part 1022, an informing part 1023, and an environment information acquiring part 1024. These functional modules may be implemented by executing programs stored in the storage unit 103 (described later) by a CPU.

The advertisement obtaining part 1021 obtains data (or advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an image or the like contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The informing part 1023 sends information about display of an advertisement to the server apparatus 20. Specifically, the informing part 1023 collects information about the present location of the vehicle, identification data of the advertisement presently displayed, and other information relating to the advertisement and sends them to the server apparatus 20.

The environment information acquiring part 1024 acquires information relating to the environment around the vehicle 10. This information will be hereinafter referred to as “environment information”. The environment information is information about the number of users who can see each of the display apparatuses provided on the vehicle 10. This information is used, for example, to estimate the distribution of users present in the vicinity of the vehicle 10.

For example, when there are many pedestrians in the vicinity of the vehicle 10, high advertising effectiveness will be achieved by displaying an advertisement on a display apparatus provided on a side of the vehicle 10. When there is another vehicle that is running behind the vehicle 10, high advertising effectiveness will be achieved by displaying an advertisement on a display apparatus provided on the rear of the vehicle 10.

The environment information acquiring part 1024 acquires information about the presence of pedestrians, vehicles and/or other users in the vicinity the vehicle 10, as environment information. The environment information may be acquired through the sensor 106 (which will be described later) or wireless communication. The distribution of pedestrians may be estimated using a map data stored in the vehicle 10 and location information. The environment information is sent to the advertisement outputting part 1022 and used in the process of controlling outputting of advertisements.

Details of processing executed by each module will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unit configured to acquire location information of the vehicle 10. The location information acquisition unit 105 includes, for example, a GPS module and acquires location information (e.g. latitude and longitude) of the vehicle 10.

The sensor 106 refers to a group of sensors provided on the vehicle 10. The sensor 106 may include any sensor capable of acquiring information about the presence of users who potentially see the advertisement displayed by the vehicle 10. For example, if the distribution of users present in the vicinity of the vehicle 10 is to be determined, the sensor 106 may include a unit for capturing images and a unit for detecting humans and vehicles in the images. As is the case with the above example, the sensor 106 is not necessarily one that directly senses a certain physical quantity. For example, the sensor 106 may obtain data relating to the presence of vehicles and pedestrians by road-to-vehicle communication or inter-vehicle communication. In the description of this embodiment, such data will also be referred to as sensor data.

FIG. 2 is given only to illustrate an exemplary configuration, and all or some of the functions shown in FIG. 2 may be implemented by circuits dedicated to the functions. Main and auxiliary storage devices other than those illustrated may be employed in combination to store and/or execute programs.

Next, the configuration of the server apparatus 20 will be described.

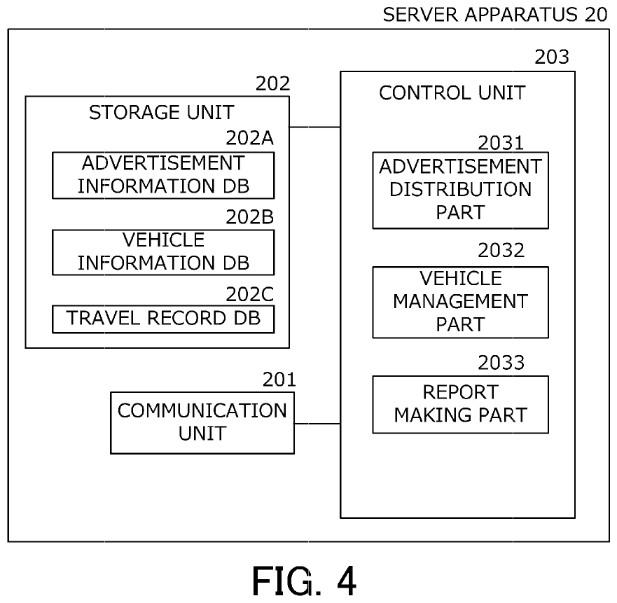

FIG. 4 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record data base 202C.

The advertisement information database 202A is a database in which data relating to advertisements to be distributed to the vehicles 10 is stored. Such data is created by an advertiser(s).

The vehicle information data base 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

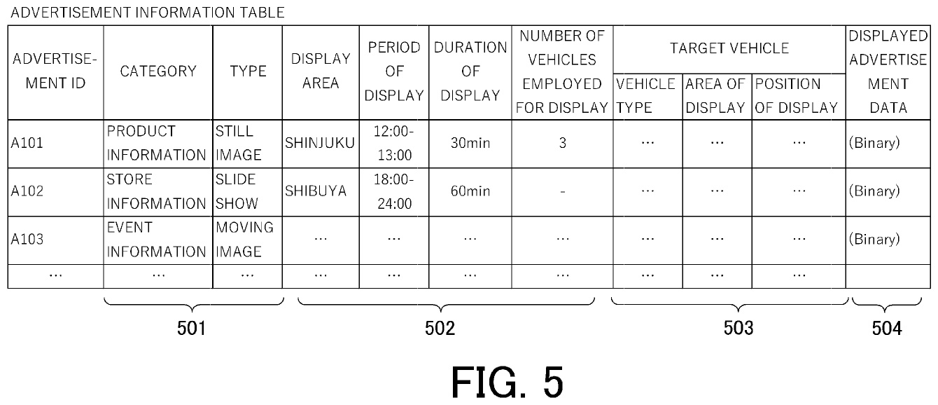

Data stored in the advertisement information database 202A will now be described with reference to FIG. 5. FIG. 5 illustrates an example of the content of an advertisement information table stored in the advertisement information database 202A. As illustrated, the information stored in the advertisement information table includes identification data of the advertisement (advertisement ID), information relating to properties of the advertisement (501), information relating to conditions for display of the advertisement (502), information designating a vehicle to be employed to display the advertisement (503), and data to be output to the display apparatus 101 of the vehicle (displayed advertisement data 504).

The displayed advertisement data may be, for example, still image data or moving image data. Each data stored in the advertisement information database 202A will be referred to as “advertisement data”.

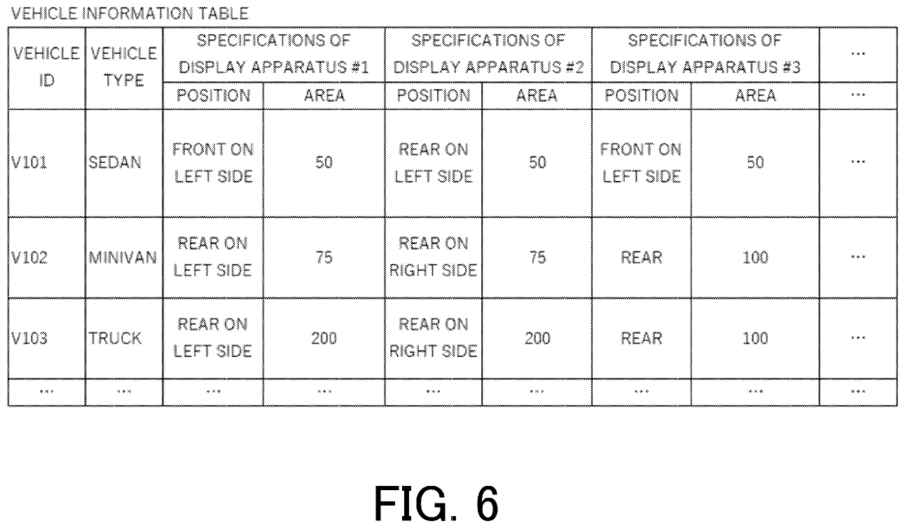

Next, data stored in the vehicle information database 202B will be described with reference to FIG. 6. FIG. 6 illustrates an example of the content of a vehicle information table stored in the vehicle information database 202B. The information stored in the vehicle information table includes information about the type of the vehicle and information about the display apparatus. Examples of the information about the display apparatus include, but are not limited to, the number of display apparatuses, the positions at which the display apparatuses are provided, and the area of each display.

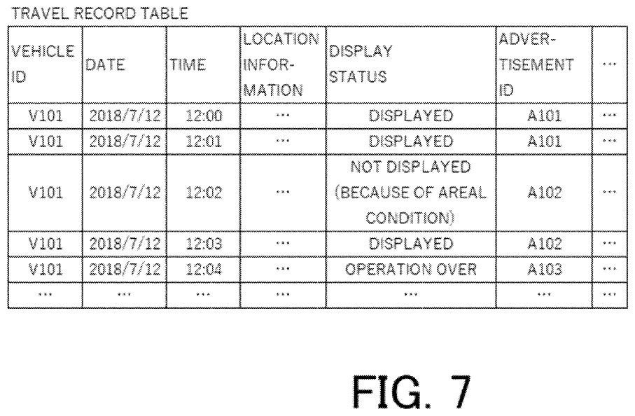

Data stored in the travel record database 202C will be described with reference to FIG. 7. FIG. 7 illustrates an example of the content of a travel record table stored in the travel record database 202C. Information stored in the travel record table includes identification data of the vehicle (VEHICLE ID), date and time, location information (e.g. latitude and longitude) of the vehicle 10, the status of display of advertisement, identification data of the advertisement displayed at the time (ADVERTISEMENT ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031 and a vehicle management part 2032. These two functional modules may be implemented by executing programs stored in auxiliary storage device by the CPU.

The advertisement distribution part 2031 determines an advertisement to be displayed by a designated vehicle 10 and sends corresponding advertisement data to the vehicle 10.

The vehicle management part 2032 periodically communicates with the vehicles 10 to collect location information of the vehicles 10 and identification data of the advertisements displayed by the vehicles 10 and updates the travel record database 202C.

The control unit 203 further includes a report making part 2033, which makes a report on advertisements and billing data based on the result recorded in the travel record database 202C.

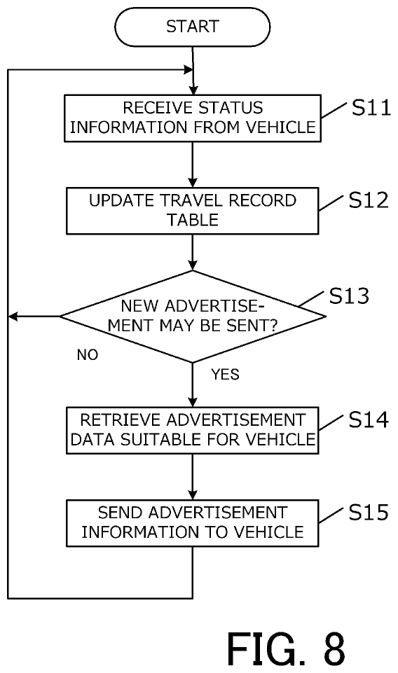

Next, we will describe how the advertisement distribution system according to the embodiment distributes advertisements to the vehicles 10 to cause them to display the advertisements. FIG. 8 is a flow chart of a process executed by the server apparatus 20. The server apparatus 20 executes the process illustrated in FIG. 8 periodically (or every unit time) for each of the vehicles 10 under its management.

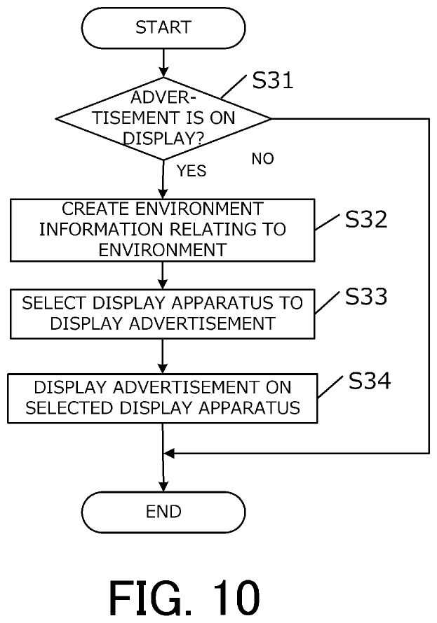

Firstly in step S11, the server apparatus 20 receives status information from the vehicles 10 under its management. The status information includes information about the present location of each vehicle, the identification data of the presently displayed advertisement, and the status of display of advertisement. In this step, specifically, the vehicle management part 2032 sends an inquiry to each of the vehicles 10 (specifically, the informing part 1023 thereof). In response to the inquiry, the informing part 1023 of each vehicle 10 sends location information acquired by the location information acquisition unit 105, information about whether or not there is an advertisement presently on display (with the ID of the advertisement, if affirmative), and the status of display of advertisement as the status information. Details of the processing performed by the vehicle 10 will be described later with reference to FIG. 10.

While in the system according to the embodiment the server apparatus 20 periodically sends an inquiry to the vehicle 10, the vehicle 10 may periodically send the aforementioned information to the server apparatus 20 by push communication alternatively. In this alternative case, the processing of step S11 is not necessarily executed at the timing indicated in FIG. 8.

Then in step S12, the server apparatus 20 updates the travel record table based on the status information received from the vehicle 10. Specifically, the vehicle management part 2032 adds a record including the vehicle ID, date, time, location information, display status, and displayed advertisement ID (if an advertisement is on display) to the travel record table stored in the travel record database 202C.

Then in step S13, it is determined whether or not new advertisement data may be sent to the subject vehicle 10 (namely, the vehicle for which this process is being performed). If a negative determination is made in step S13, the process proceeds to step S11, and the subject of the process is changed to another vehicle 10.

Whether or not new advertisement data may be sent to a certain vehicle 10 can be determined by whether or not the properties of the vehicle 10 satisfy the condition set for each advertisement. For example, in the case where a condition relating to the vehicle type and the display apparatus of the vehicle (like data 503 in FIG. 5) is set, whether or not new advertisement data may be sent to a certain vehicle 10 is determined by whether or not the properties of the vehicle 10 meet this condition.

Alternatively, whether or not advertisement data may be sent to a certain vehicle 10 may be determined by consulting information about the vehicle 10. For example, information about the taste of the owner of the vehicle 10 may be stored in the vehicle information table, and an advertisement to be distributed to the vehicle 10 may be determined using this information. Whether or not advertisement data may be sent may be determined based on the number of pieces of effective advertisement data stored in the vehicle 10.

If there is an advertisement for which the subject vehicle 10 meets the condition, information relating to the advertisement is retrieved (in step S14) and sent to the vehicle 10 (step S15).

Even when it is determined that advertisement data may be sent to the vehicle 10, there may be cases where the advertisement data is not sent for the reason that a certain condition relating to the vehicle is not met. For example, the reception of advertisement data may be rejected by the vehicle 10 in some circumstances.

The above-described process is executed repeatedly for every vehicle 10 under the management of the server apparatus 20.

Next, the process executed by the vehicle 10 will be described. The process executed by the vehicle 10 can be divided into two processes. A first process is the process of sending and receiving data relating to advertisement to and from the server apparatus 20 and starting and stopping display of an advertisement. A second process is the process of changing the position of display of the advertisement.

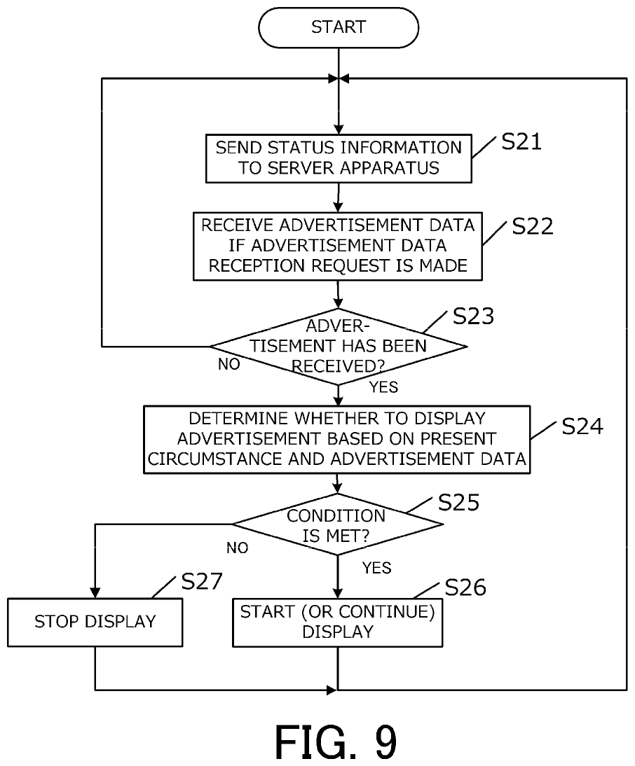

FIG. 9 is a flow chart of the first process executed by the vehicle 10. This process is executed by the vehicle 10 at the time when the inquiry from the server apparatus 20 is received.

Firstly, in step S21, the informing part 1023 sends the following information to the server apparatus 20:

(1) location information acquired by the location information acquisition unit 105

(2) the presence/absence of displayed advertisement (with its ID, if present)

(3) the status of display of advertisement

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of steps S21 is not necessarily executed at the timing indicated in FIG. 9.

Then, in step S22, it is determined whether or not reception of advertisement data is requested by the server apparatus 20, and if it is requested, the vehicle 10 receives the advertisement data.

Then, in step S23, it is determined whether or not the advertisement outputting part 1022 has already received the advertisement data from the server apparatus 20. If a negative determination is made in step S23 (i.e. the vehicle 10 has no advertisement data), the process returns to step S21. If an affirmative determination is made in step S23, the process proceeds to step S24, where it is determined whether or not the advertisement is to be displayed on the basis of comparison between the present circumstance and the condition set in the advertisement data the vehicle 10 has received.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S24 indicates that the condition is met (Yes in step S25), the process proceeds to step S26, where display of the advertisement is started (or continued, if the advertisement has already been displayed). If data of a plurality of advertisements are stored in the vehicle 10, the advertisement to be displayed may be selected according to a certain condition.

If the condition is not met (No in Step S25), the process proceeds to step S27, where display of the advertisement is ended.

In step 27, it may be determined whether or not display of the advertisement is to be ended. For example, in the case where a total display time is designated for a certain advertisement, if the total display time of the advertisement has elapsed, it is determined that display of this advertisement is to be ended. Furthermore, if the operation (or travel) of the vehicle 10 that displays a certain advertisement ends (e.g. if the ignition is turned off), it is determined that display of the advertisement is to be ended. After display of an advertisement is ended, the advertisement data for this advertisement may be deleted.

The vehicle 10 displays the advertisement by the above process.

Next, the second process executed by the vehicle 10 will be described with reference to FIG. 10. This process is executed by the control unit 102 periodically while the vehicle 10 is travelling.

Firstly, in step S31, it is determined whether or not an advertisement is presently being displayed. If no advertisement is being displayed, the process is ended. Then, the process is not executed until the start of the next cycle.

If an advertisement is being displayed, then in step S32 the environment information acquiring part 1024 creates environment information based on information acquired by the sensor 106. The environment information is information relating to the presence of users who can see each of the plurality of display apparatuses, as described above.

Examples of the environment information are as follows.

(1) the number of pedestrians present in the vicinity of the vehicle 10

The average number of pedestrians present in the vicinity of the vehicle 10 over a predetermined length of time (e.g. one, three, five, or ten minutes) may serve as the environment information. The number of pedestrians can be counted by detecting humans in an image(s) captured by an on-vehicle camera. Alternatively, the number of pedestrians may be counted (or estimated) based on information obtained from mobile terminals that pedestrians have. The number of pedestrians may be determined using an external service. The larger the number of pedestrians is, the more advantageous the display of an advertisement on a side of the vehicle is.

(2) the geographical distribution of pedestrians present in the vicinity of the vehicle 10

Moreover, the distribution of pedestrians about the vehicle 10 may be obtained. This enables estimation of the number of pedestrians who can see each of the plurality of display apparatuses. The distribution is not required to be exact data. For example, when the vehicle 10 is running on a road having two or more lanes, it may be determined that a larger number of pedestrians are distributed on the left side (seen in the direction of travel) of the vehicle than the right side (in the case of left-hand traffic).

(3) the geographical distribution of other vehicles present in the vicinity of the vehicle 10

For example, when another vehicle is present on the left or right side or behind the vehicle 10, it can be supposed that the display apparatus provided at the corresponding position can be seen from the other vehicle. Therefore, environment information can be obtained by detecting the presence of other vehicles on the left right side, on the left side, and behind the vehicle 10.

In this case, information about the model and the size of the other vehicles may be included in the environment information. This is because there may be a display apparatus that cannot be seen clearly from some vehicles due to some properties of vehicles (e.g. the position of the driver's eyes). For example, a display apparatus provided on a side of an ordinary automobile can hardly be seen from a large-size vehicle running alongside in some cases.

The environment information obtained in step S32 is not limited to those described above, but it may be any information relating to something that affects the visibility of the advertisement.

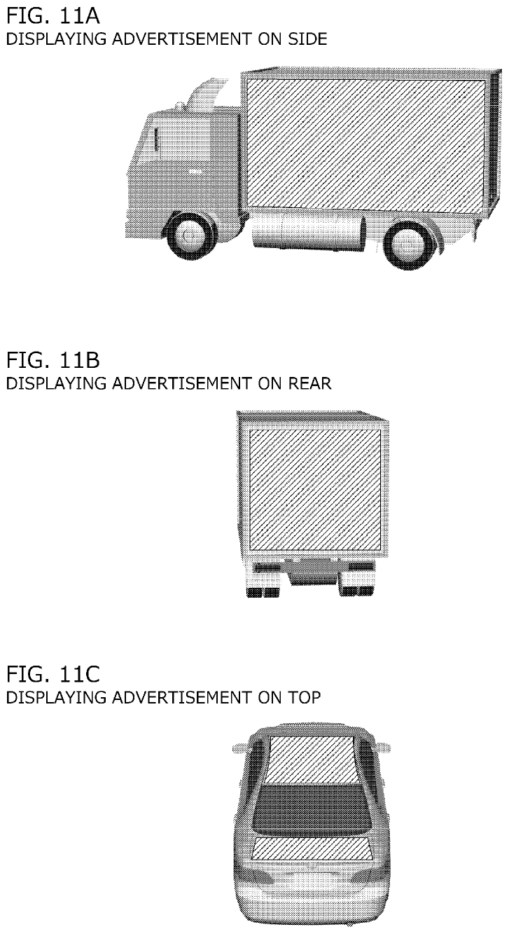

Then, in step S33, the position of display of an advertisement to be displayed is determined based on the environment information obtained as above. In this embodiment, three cases will be described, specifically a case where the advertisement is displayed on a side of the vehicle, a case where the advertisement is displayed on the rear of the vehicle, and a case where the advertisement is displayed on the top of the vehicle, as illustrated in FIGS. 11A to 11C.

For example, when the environment information indicates that there are many pedestrians in the vicinity of the vehicle 10, it is preferable that the advertisement be displayed on a side of the vehicle 10 as illustrated in FIG. 11A. In the case where the vehicle 10 is provided with independent display apparatuses on both the left and right sides (seen in the direction of travel), the determination may be made about the two display apparatuses independently from each other. For example, if the road on which the vehicle 10 is travelling has a median strip, it may be determined that the display apparatus on the right side are hardly seen (in the case of left-hand traffic).

When the environment information indicates that there is another vehicle behind the vehicle 10, it is preferable that the advertisement be displayed on the rear of the vehicle 10 as illustrated in FIG. 11B.

When the environment information indicates that there is a large-size vehicle (having a larger height than the vehicle 10) behind the vehicle 10, it is preferable that the advertisement be displayed on the top of the vehicle 10 as illustrated in FIG. 11C.

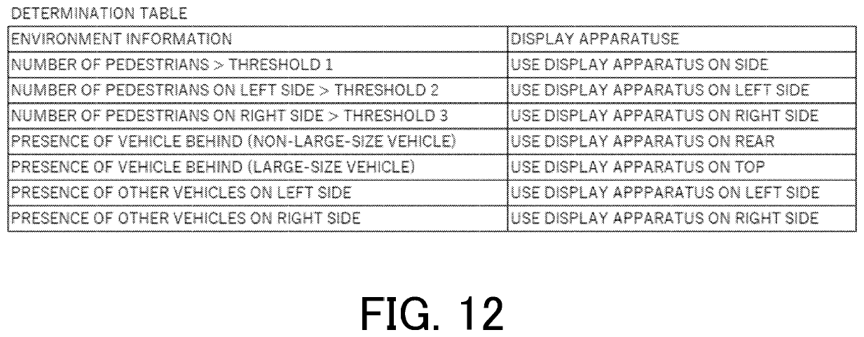

FIG. 12 is an exemplary table (determination table) that associates the circumstance indicated by the environment information with the display apparatus to be used. The determination in step S33 may be carried out using such a table. When a plurality of conditions are met, it may be determined that a plurality of display apparatuses are to be used at the same time.

Then in step S34, the advertisement is displayed using the display apparatus determined to be used. When a plurality of display apparatuses are to be used, the same advertisement may be displayed on all of the display apparatuses used, or different advertisements may be displayed on different display apparatuses. For example, when a certain advertisement is not allowed to be displayed on a display apparatus provided at a specific position (because of, for example, a certain condition specified in the section 503 in the table in FIG. 5), another advertisement may be displayed.

As above, the advertisement distribution system according to the first embodiment obtains information relating to the environment around the vehicle 10 employed to display advertisements and performs a control to display an advertisement at a position that provides higher visibility of the advertisement. This can enhance the effectiveness of the advertisement.

(Modification of First Embodiment)

The above embodiment is only for the illustrative purpose. Appropriate modifications can be made thereto without departing from the essence of the present invention.

For example, in the above description of the embodiment, it is basically assumed that the same advertising content is output to all of the plurality of display apparatuses. However, different advertisement contents may be output to different display apparatuses. For example, a plurality of versions of advertisement of the same subject that have different amounts of information and different contents may be prepared, and suitable versions may be output to the respective display apparatuses.

In the case where properties of uses who see advertisements are available, advertisements suitable for the properties of the users may be selected. For example, data of the gender, age, and/or taste of a user may be obtained by inter-vehicle communication or pedestrian-to-vehicle communication, and an advertisement suitable for that user may be selected to be output in step S34. Moreover, a plurality of versions of advertisement of the same subject that have different amounts of information and different contents may be prepared, and a suitable version may be selected according to the properties of the user. For example, the amount of information and/or the font size may be determined according to the age of the user.

Information about the vehicle on which a user who sees advertisements is aboard may be obtained to select a suitable advertisement. For example, information about the type and/or the model of the user's vehicle may be obtained by inter-vehicle communication, and a suitable advertisement may be selected to be output in step S34. A plurality of versions of advertisement of the same subject that have different amounts of information and different contents may be prepared, and a suitable version may be output according the state of the user's vehicle. For example, the higher the speed of the user's vehicle is, the smaller the amount of information of the advertisement may be made.

While in the above-described embodiment the position at which the advertisement is displayed is determined based on the presence of pedestrians and other vehicles, the position at which the advertisement is displayed may be determined based on other factors. For example, when the vehicle 10 is travelling in an area in which people can look down the vehicle 10 from above, such as an area where a lot of aircrafts (e.g. drones) fly or an area where there are a lot of high-rise condominiums, the advertisement may be output to the display apparatus provided on the top of the vehicle 10. Such a determination may be carried out using map information or the result of sensing of aircrafts or high-rise buildings.

(Other Modifications)

The processing and means that have been described in the foregoing may be employed in any combinations so long as it is technically feasible to do so.

For example, the process of selecting a display apparatus(es) executed by the vehicle 10 in the above-described system according to the embodiment may be executed by the server apparatus 20 alternatively. In this alternative case, the process according to the flow chart in FIG. 10 may be incorporated in the process according to the flow chart of FIG. 9.

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present invention can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD disc and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus comprising a controller configured to execute the processing of:
acquiring information relating to the environment around a vehicle that is capable of outputting an advertisement by a plurality of outwardly facing display apparatuses provided at different positions;
selecting a display apparatus to which the advertisement is to be output from among the plurality of display apparatuses on the basis of the environment around the vehicle; and
outputting the advertisement to the selected display apparatus.

2. An information processing apparatus according to claim 1, wherein
the information relating to the environment around the vehicle includes information about the area in which the vehicle is travelling.

3. An information processing apparatus according to claim 1, wherein
the information relating to the environment around the vehicle includes at least one of information about the state of distribution of pedestrians in the vicinity of the vehicle, information about the state of distribution of other vehicles in the vicinity of the vehicle, and information about the presence/absence of another vehicle that is running behind the vehicle.

4. An information processing apparatus according to claim 1, wherein
when the information relating to the environment around the vehicle indicates that a pedestrian is present aside the vehicle, the controller outputs the advertisement to a display apparatus provided on a side of the vehicle.

5. An information processing apparatus according to claim 1, wherein
when the information relating to the environment around the vehicle indicates that another vehicle is present behind the vehicle, the controller outputs the advertisement to a display apparatus provided on the rear of the vehicle.

6. An information processing apparatus according to claim 1, wherein
when the information relating to the environment around the vehicle indicates that another vehicle having a height larger than the vehicle is present behind it, the controller outputs the advertisement to a display apparatus provided on the top of the vehicle.

7. An information processing apparatus according to claim 5, wherein
the controller further obtains information relating to properties of the another vehicle and determines the content of the advertisement based on the information about the another vehicle.

8. An information processing method executed by an information processing apparatus, the method comprising the steps of:
acquiring information relating to the environment around a vehicle that is capable of outputting an advertisement by a plurality of outwardly facing display apparatuses provided at different positions;
selecting a display apparatus to which the advertisement is to be output from among the plurality of display apparatuses on the basis of the environment around the vehicle; and
outputting the advertisement to the selected display apparatus.

9. A non-transitory computer readable storing medium recording a computer program for causing a computer to perform a method comprising:
acquiring information relating to the environment around a vehicle capable of outputting an advertisement by a plurality of outwardly facing display apparatuses provided at different positions;
selecting a display apparatus to which the advertisement is to be output from among the plurality of display apparatuses on the basis of the environment around the vehicle; and
outputting the advertisement to the selected display apparatus.
